(19) United States
(12) Patent Application Publication
(10) Pub. No.: US 2014/0120319 A1
(43) Pub. Date: May 1, 2014

(54) 3D MAPPING USING STRUCTURED LIGHT AND FORMATION OF CUSTOM SURFACE CONTOURS

(71) Applicant: Benjamin E. Joseph, Oakland, CA (US)

(72) Inventor: Benjamin E. Joseph, Oakland, CA (US)

(21) Appl. No.: 14/068,859

(22) Filed: Oct. 31, 2013

Related U.S. Application Data
(60) Provisional application No. 61/721,031, filed on Nov. 1, 2012.

(51) Int. Cl. H04N 13/02; B32B 3/26

(52) U.S. Cl. CPC H04N 13/0253; B32B 3/263
USPC 428/172; 348/46; 156/64

(57) ABSTRACT

A 3D mapping apparatus is provided that includes a light source, a projector, and a portable device. The projector is constructed to project a structured light pattern onto a target object. The projector includes an interface enabled to collects light from the light source, a grating that corresponds to the structured light pattern, and a lens interposed between the light source and the target object. The portable device includes an integrated camera for capturing light reflected from the target object and generating an image therefrom. Also included is a storage medium enabled to store the image. The camera and the lens of the projector are located at a predetermined distance from each other. Also provided are multicomponent items having a desired surface contour and method for producing such items.

### CROSS REFERENCE TO RELATED APPLICATIONS

This application claims priority to U.S. Provisional Application Ser. No. 61/721,031, entitled “Structured Light Apparatus and System for the Creation Custom Orthotics,” filed on Nov. 1, 2012, by inventor Benjamin Joseph, the disclosure of which is incorporated by reference in its entirety.

### BACKGROUND

There are numerous ways to gather three-dimensional (3D) information of an object such as its shape, dimensions, and surface profile. Generally, 3D scans are used to generate a “point cloud”, which is a collection of points in a three dimensional space. Each point represents a point on the surface of the scanned object. In essence, the point cloud forms a 3D map of the object's surface.

Cameras, image sensors, or other image recorders may be used generate the point cloud through a structured light technique. The technique involves projecting a known pattern, e.g., an array, of light onto the target object. For example, an array of horizontal bars can be projected onto a surface. The distortion of the pattern by the unevenness of the surface can then be used to determine the shape of the surface to high accuracy. Thus, when a picture (or another image sensing technique) is taken of the target object illuminated with a structured light source, it is possible to determine the shape of the object with the information in the picture.

Structured light techniques have often utilized a method called Moiré interferometry, which was applied to visualize strains on structural elements placed under a load. A target object such as a metal plate would have a series of fine parallel lines painted onto its surface, or projected on the object's surface with a bright lamp, lens system, and fine grating. The object would be loaded in tension or compression, and when the object was viewed through a reference grating, the resulting interference between the distorted object and the reference grid would indicate the displacement of the object towards or away from the viewer. The accuracy of this method is on the same order as the dimensions of the painted pattern and reference grating. Using gratings with spacing on the order of 10 micrometers, for example, features less than 10 micrometers can be accurately resolved.

In the early 1980s, computers enabled using structured light for scanning complicated 3D objects in a completely digital fashion. As exemplified in Gasvik, (1983) “Moire technique by means of digital image processing,” APPLIED OPTICS, 22(22):3543-48, advanced computational capabilities in computers enabled more complicated structured light techniques. For example, light patterns other than lines may be used (e.g. circles), and time-varying patterns may be used to analyze objects (especially moving objects).

For example, U.S. Pat. No. 8,462,207 to Garcia et al. describe a method for three-dimensional mapping of an object, including projecting with a projector a set of fringes on the object and capturing an image of the object in a camera. The method further includes processing the captured image so as to detect a Moire pattern associated with the object and so as to extract depth information from the Moire pattern, and configuring the projector and the camera so that a locally unambiguous characteristic of the Moire pattern is related to a depth of the object.

Many modern structured light techniques involve recovering a phase signal of a periodic pattern that yields the shape of the object. Whether the pattern is two-dimensional pseudo-random sequence, a sinusoidal pattern, a regular grid of dots, the basic principle is the same. While these newer techniques yield performance gains (e.g. higher resolution), these are effectively just refinements to the original Moiré interferometry techniques.

3D scanning technology that employs structured light techniques has been adapted for use in various fields of endeavor. For example, U.S. Pat. No. 8,121,718 to Rubbert et al. describes a computerized, interactive system for orthodontic treatment. The system includes a hand-held optical scanner capturing 3D information of objects, interactive computer-based treatment planning using three-dimensional tooth objects and user specified simulation of tooth movement, and appliance manufacturing apparatus, including bending machines. Similarly, U.S. Pat. No. 8,509,501 to Hassebrook et al. describes a biometrics system that captures and processes a handprint image using a structured light illumination to create a 2D representation equivalent of a rolled inked handprint.

Recently, a number of infrared-based technologies have been developed to track motion in 3D. For example, Microsoft Corporation (Redmond, Wash.) has brought to market Kinect® motion-sensing input devices that work with Xbox 360® interactive video game consoles. Such motion-sensing devices typically employ an infrared laser projector in combination with a monochrome CMOS sensor, which captures video data in 3D under ambient light conditions. While such motion-sensing devices are well suited for tracking the movements of gamers, the devices are relatively complex in construction and may not possess sufficient imaging sensitivity for static 3D contour mapping purposes.

Structured light techniques have so far been overlooked in a number of substantially static mapping applications. For example, 3D scanning techniques have not been widely used to produce items having a surface contour personalized for an individual, e.g., custom orthotics, ergonomic devices, etc. Instead, such items are typically made through traditional time-consuming and costly casting techniques. Often, a podiatrist will produce custom orthotics by first making a plaster cast to provide a negative impression of the patient's foot. The cast is sent to a laboratory with a prescription for recommended modifications.

At the laboratory, a positive cast may be made by pouring plaster into the negative cast. When the plaster dries and is removed, a reproduction of the bottom of the foot is formed. Using the podiatrist's recommendations for corrections, laboratory technicians will custom-mold an orthotic made of a supportive material that incorporates the podiatrist's recommended adjustments.

Alternatively, the laboratory may begin the production process by laser scanning the negative cast. The information may then be processed by a computer to produce the digital image on screen. After corrections are implemented, the corrected positive cast is ready to be produced.

Advances in microelectronics have resulted in considerable improvements in the functionality of mobile devices such as smart phones, tablet computers, and notebook/laptop computers. Such portable devices have now been recognized to possess both computational resources and a high-resolution camera that may be exploited for 3D scanning purposes. However, current mobile devices cannot yet perform structured light techniques for 3D imaging.

Thus, there exist opportunities to leverage the advances in mobile devices for 3D scanning purposes to produce items having a surface contour personalized for an individual, thereby eliminating the need for making casts.

### SUMMARY

In a first embodiment, a 3D mapping apparatus that includes a light source, a projector, and a camera. The projector is constructed to project a structured light pattern onto a target object. The projector includes an interface enabled to collects light from the light source, a grating that corresponds to the structured light pattern, and a lens interposed between the light source and the target object. The camera may be an integrated component of a portable device, e.g., a cellular phone or tablet computer with wireless networking capabilities, and may serve to capture light reflected from the target object and to generate an image therefrom. Also included is a storage medium enabled to store the image. The camera and the lens of the projector are located at a predetermined distance from each other.

In another embodiment, a multicomponent item is provided having a desired surface contour. The item includes a first component, e.g., a stock component having a first surface and a first bonding surface, and a second component, e.g., a custom component, comprising a custom surface and a second bonding surface. The first bonding surface and second bonding surface are enabled to bond with each other. The custom surface forms at least a portion of the desired surface contour of the item. For example, the multicomponent item may form a portion or the entirety of an orthotic, medical, dental and/or ergonomic device, e.g., personalized for a human or animal.

Methods are provided as well for producing a multicomponent item having a desired surface contour customized for an individual. Typically, a digital 3D map, optionally modified from an initial 3D image file, is obtained associated with the individual. A custom component is formed from the digital 3D map. The custom component relative is then immobilized to a stock component to form the multicomponent item. The personalized surface contour is associated at least in part with a surface of the custom component. Optionally, the custom component may be printed from the digital 3D map on a stock component to form the multicomponent item.

The digital 3D map may be obtained in any of a number of ways. For example, a structured light pattern may be projected from an incident direction onto the individual. The digital map may be produced after receiving light reflected from the individual at an angle of greater than zero to about ninety degrees relative to the incident direction. In addition or in the alternative, the 3D map may be formed produced from a data file, modified or otherwise, associated with the individual that may not be a result of structure light pattern techniques.

### BRIEF DESCRIPTION OF THE DRAWINGS

FIG. 1 illustrates the need for parallax between a structured light source and camera for determining the depth of an object.

FIG. 2 depicts a system utilizing structured light and a camera to determine the shape of a 3D object.

FIGS. 3A to 3D, collectively referred to as FIG. 3, depicts an exemplary projector of the invention in combination with an exemplary portable device that may be used to carry out 3D scans. FIG. 3A depicts an integrated grating and lens assembly of the projector. FIG. 3B depicts a light pipe of the projector. FIG. 3C depicts and exemplary mobile device having an integrated camera and a flash lamp. FIG. 3D depicts how the projector components shown in FIGS. 2A and 3D may be affixed to the mobile device shown in FIG. 3 to form a 3D mapping apparatus.

FIG. 4 provides a flow chart that exemplifies how an orthotic many be produced based on 3D scan.

FIG. 5 depicts how background clutter may be removed from a scan of a foot

FIG. 6 depicts exemplary key points on the scan of a human foot.

FIG. 7 depicts how the rotation of the foot may be computed with respect to an ideal coordinate frame

FIG. 8 depicts how parts of a foot scan not related to the production of the orthotic may be removed.

FIG. 9 depicts how an orthotic based on foot point cloud data may be constructed, wherein some sections of the foot are ignored while others are contoured as with the shape of the foot.

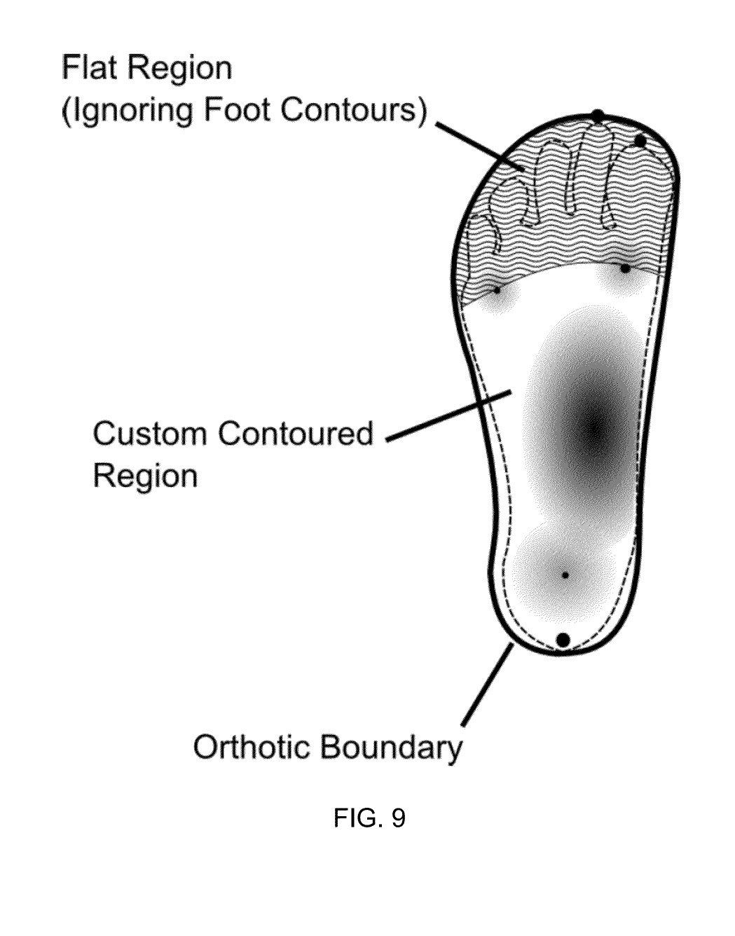

The invention and aspects thereof shown in the figures may not necessarily be depicted to scale, and certain dimensions may be exaggerated for clarity of presentation.

### DETAILED DESCRIPTION OF THE INVENTION

Definitions and Overview

Before describing the present invention in detail, it is to be understood that the invention is not limited to any specific manufacturers of portable devices as such may vary. It is also to be understood that the terminology used herein is for the purpose of describing particular embodiments only, and is not intended to be limiting.

In addition, as used in this specification and the appended claims, the singular article forms “a,” “an,” and “the” include both singular and plural referents unless the context clearly dictates otherwise. Thus, for example, reference to “a light source” includes a single light source as well as an assembly of light sources, reference to “a camera” includes a plurality of cameras as well as a single camera, and the like.

In this specification and in the claims that follow, reference will be made to a number of terms that shall be defined to have the following meanings, unless the context in which they are employed clearly indicates otherwise:

The terms “camera” and “optical recording device” are interchangeably used herein and refer to an optical instrument capable of recording photographic images that can be stored directly, transmitted to another location, or both. Typically, a camera includes an enclosed hollow with an aperture at one end for light to enter, a recording surface for capturing light at another end, and a lens positioned to gather the incoming light and focus all or part of the image on the recording surface, e.g., an sensor such as a charge couple device (CCD) or a complementary metal-oxide semiconductor (CMOS) active pixel image sensor.

The term “custom” and “customized” are interchangeably used in their ordinary sense and refer to an item that is tailor made for a particularized specification or fit. For example, a customized surface may be exhibit a contour personalized for a human individual or a desired contour to suit specific particularized requirements for a unique situational function.

The term “contour” is used in its ordinary sense and refers the outline or shape of an object, e.g., a figure or body.

The terms “electronic,” “electronically,” and the like are used in their ordinary sense and relate to structures, e.g., semiconductor microstructures, that provide controlled conduction of electrons, holes or other charge carriers.

The term “feature resolution” as in “feature resolution of a desired contour” is used to refer to the fineness of detail required to distinguish whether the desired contour is present. For example, when the desired contour of a structure comports a cube, the feature resolution of the cube's contour must be sufficiently fine to account for the fact that a cube has congruent square surfaces, orthogonal edges, etc. Thus, the feature resolution of a cube having a volume of one cubic meter must be much finer than one meter, e.g., one centimeter. Otherwise, the cube may not be distinguishable from a sphere of a one-meter diameter.

The term “internet” is used herein in its ordinary sense and refers to an interconnected system of networks that connects computers around the world via the TCP/IP and/or other protocols. Unless the context of its usage clearly indicates otherwise, the term “web” is generally used in a synonymous manner with the term “internet.”

The term “mobile device” is used in its ordinary sense and refers to a portable, computing device, typically less than about 1 kg, that is small enough to be used while held in the hand. Typically, mobile devices are wireless in nature and are powered by one or more secondary (rechargeable) batteries, though mobile devices may be powered by primary (nonrechargeable) batteries or wired powered sources.

“Optional” or “optionally” means that the subsequently described circumstance may or may not occur, so that the description includes instances where the circumstance occurs and instances where it does not.

The term “orthotics” is used to refer to a support, brace, or splint used to support, align, prevent, or correct the function of movable parts of the body. Exemplary orthotics include shoe inserts that are intended to correct an abnormal or irregular walking pattern, by altering slightly the angles at which the foot strikes a walking or running surface. Other orthotics include neck braces, lumbosacral supports, knee braces, and wrist support.

The term “particulate matter” is used to refer liquid and/or solid materials that exist or existed in the form of minute separate particle, e.g., as a powder or as aggregated granules. Typically, particulate matter used to form any particular structure has an average and/or maximum particle size appropriate to the structure's “feature resolution.”

The term “stock” is used herein to refer to components that are ready-made, optionally identical in construction, typically in relatively large quantities, e.g., made according to a standardized format rather than developed for specialized or individual needs.

The term “storage medium” is used in its ordinary sense and refers to any device or material on which data can be electronically placed, kept, and retrieved, regardless whether the data is stored permanently, e.g., via magnetic disk drives, optical disk, etc., or temporarily, e.g., by way of volatile random access memory modules.

The term “structured” as used to describe a light pattern refers having a well-defined or highly organized form. For example, a structured light pattern may take the form of an array, a two-dimensional arrangement of light features regularly ordered in a rectilinear grid, parallel stripes, spirals, and the like, but non-ordered arrays may be advantageously used as well.

The term “substantially instantaneous” is used to refer to one or more events that to a considerable degree occur or are completed with no delay, but that the absolute absence of any delay is not required. For example, when cloud point or imaging information is transmitted in a “substantially instantaneous manner,” the information must be received within a few seconds of being sent. The terms “substantial” and “substantially” are used analogously in other contexts involving an analogous definition.

The term “wireless” is used herein in its ordinary sense and refers to any of various devices that are operated with or actuated by electromagnetic waves rather than via wire or other physical connections.

In general, structured light techniques are provided for 3D mapping applications. The techniques involve providing 3D mapping apparatus that includes a light source, a projector, and a portable device. The projector is constructed to project a structured light pattern onto a target object via an interface that collects light from the light source. The portable device includes an integrated camera that may capture light reflected from the target object and generate a typically static image therefrom. Typically, the device also includes a storage medium that may store the image generated by the camera.

In some instance, a 3D map of the target may be generated from the image stored in the storage medium. The map may be generated by the device or remotely. In addition or in the alternative, the device may include a processor that receives signals from the camera to produce an electronic file associated with a digital 3D map of the target object. The file may be transmitted via wireless or other means to a network for further processing at a remote location.

As discussed above, mobile devices such as smart phones, tablet computers, and notebook/laptop computers now possess both computational resources and a high-resolution camera that may be exploited for 3D scanning purposes. Even some digital single-lens reflex cameras may have significant computational and wireless networking capabilities that render them suitable for 3D scanning purposes. However, current mobile devices cannot perform structured light techniques for 3D imaging because such devices do not have all elements 3D mapping elements. For example, mobile devices are not typically constructed with a source of structure light.

Thus, in one embodiment of the invention, a portable device is enhanced with a structured light source that is physically separated from one or more optical recording devices so as to perform 3D scans. Moreover, the structured light source and one or more optical recording devices have a known geometric relationship. The projector and the camera are located at a predetermined distance from each other. Typically, the projector and the camera immobilized relative to each other, e.g., the projector may be affixed to the portable device. As a result, the camera and the lens of the projector are located at a fixed distance from each other, e.g., at least about 2 to 5 cm from each other. Optionally, the light source is an integrated component of the portable device

It should also be noted that 3D scanning had generally been limited to generating 3D images for viewing, e.g. in a computer aided drawing (CAD) program. However, inexpensive low volume production techniques such as 3D printing are now capable of enabling scanning a 3D object and incorporating the scan of the object into a customized, “one-off” product. Thus, in another embodiment, the invention provides for manufacturing of multicomponent items having a custom surface contour, e.g., a desired surface contour personalized for an individual.

For example, the invention may involve the use of a 3D mapping apparatus to scan an individual's foot. Such a scanning apparatus may employ a “structured light” method, which is carried out with a mobile device with a camera, e.g., an iPhone® mobile device, to produce 3D scans of any object. As a result of the scan in conjunction with information technology infrastructure that may account for non-ideal 3D scan data, a custom orthotic may be created that is tailored to the shape of the foot. In turn, an inexpensive but high performance orthotic may be produced.

Thus, another embodiment of the invention provides a multicomponent item, e.g., a custom orthotic, having a desired surface contour. Each of first and second components has a bonding surface that may be bonded with each other. The second component has a custom surface that forms at least a portion of the desired surface contour. Typically, a surface of the first component and the custom surface together form a hybrid surface of the desired surface contour. Alternatively, the custom surface in itself exhibits the desired surface contour.

Such an item may be produced in a customized manner for an individual by first obtaining a digital 3D map associated with the individual. After a custom component is formed from the digital 3D map, the component may be bonded to a stock component. As a result, the multicomponent item is formed having a surface contour customized for the individual.

It should be noted that such a multicomponent-type approach provides a number of advantages over a pure custom production approach. While it is possible to produce the item entirely from one or more custom components, stock components are typically less expensive to produce in volume ahead of time. In addition, the use of stock components may alleviate the demand for custom item production resources, which may reduce the order-to-turnaround time associated with pure custom component approaches.

3D Mapping

Structured light 3D mapping techniques generally share a number of common elements. For example, such techniques require a structured light source to illuminate (e.g., shine parallel lines on) a target object. Such techniques also require a camera or similar optical recording device to capture light reflected from the target object. A known geometric relationship between the target object, the camera, and the source of structured light is required to produce an accurate point cloud representing the surface contour of the target object.

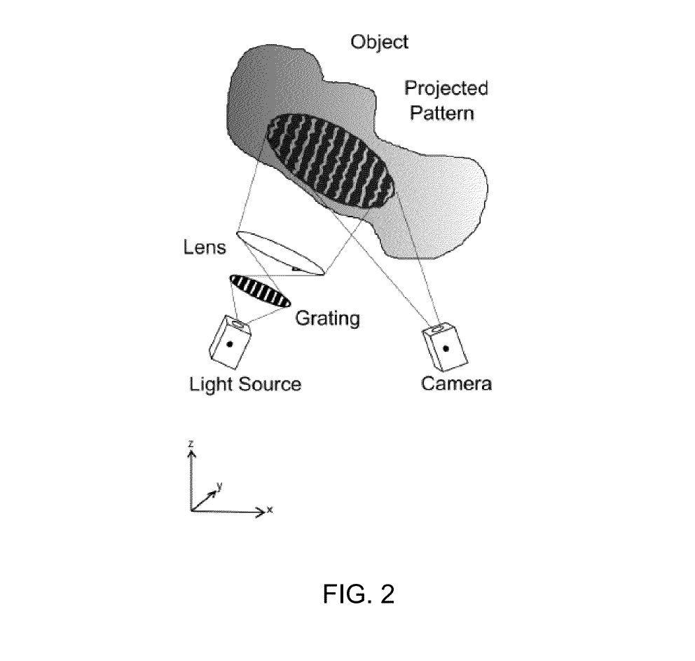

FIG. 2 depicts a conceptual illustration of 3D scanning using structured light. As shown, a target object is illuminated by a structured light pattern. Light emerging from the light source is passed through a grating and focused by a lens onto the target object. Optionally, the grating and the lens may be provided as an integrated projector. Also shown is a camera that captures light reflected from the target object.

Notably, FIG. 2 depicts physical separation between the light source/projector and the camera. This depiction is consistent with another element required for 3D mapping techniques, i.e., sufficient distance between the structured light source and optical recording device to be physically separated so as to provide a parallax necessary for depth measurements. Parallax is a displacement or difference in the apparent position of an object viewed along different sight lines. Thus, when an object is viewed from a slant, variations of its depth are observable as changes in angle from the viewer. For example, if one were to fly in a plane over a tall building, the building's height would not be apparent when the plane is directly over the building. In contrast, once the plain is no longer directly over the building the building's height can be easily ascertained from the offset perspective.

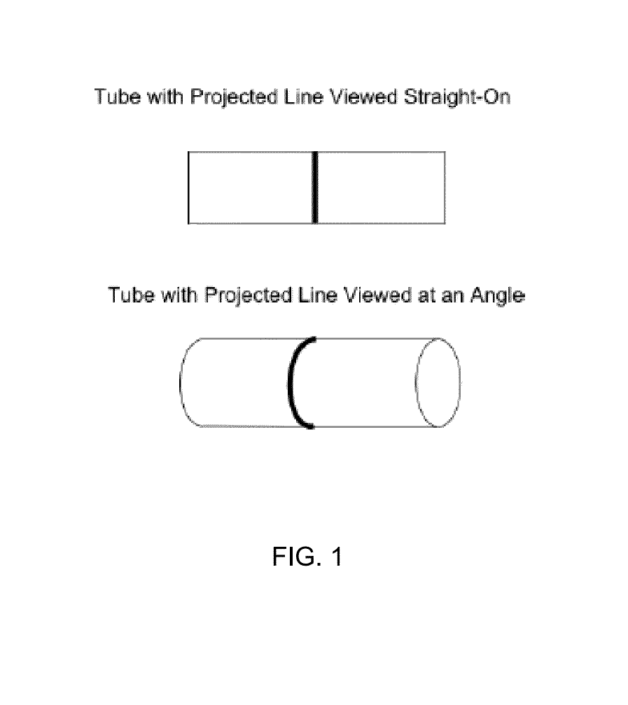

FIG. 1 depicts the need for parallax between structured light source and camera for determining the depth of an object. When a line is projected on a cylinder, the viewer will only observe a straight line on a curved surface when the viewed from the same direction as the illumination source. When the viewing direction is different from the illumination direction, the curved profile of the cylinder will become apparent, as slope of the projected line is proportional to the slant of the surface. In other words, as the angular separation from viewer and projector increases, so does the slope of the projected line. Thus, the sensitivity of structured light techniques depends the parallax.

As discussed above, such a camera may be provided as an integrated component of a mobile device such as a cellular phone. Unmodified, however, mobile devices such as cellular phones by themselves are generally unsuitable for 3D mapping applications. Although structured light may be produced on a mobile device's display screen, the illumination from the display screen is too dim for general operability anywhere except in a darkened room. In contrast, many modern mobile phones include an integrated a flash lamp for low-light photography. The flash lamp can be quite bright, and can provide sufficient illumination in many indoor daylight settings.

Thus, one novel and nonobvious aspect of the invention provides a means for generating a structured light pattern from an integrated light source of a mobile device. As alluded to above, the integrated flash lamps of cell phones generally can only illuminate, but cannot project a structured pattern. All that is needed, in concept, to produce structured light is a grating interposed between the lamp and the target object. Once the grating image is formed, the image may then be focused by one or more lenses to project a structured light pattern onto the target object.

From a practical perspective, it should be noted that in current mobile devices having an integrated camera and flash lamp construction, the distance separating the camera and flash is quite small, usually one centimeter or less. Such a small separation distance is well suited for ordinary photographic activities, e.g., taking portraits of target objects without shadow. However, such a small separation distance between the flash lamp as a source of structured light pattern and the camera to capture light reflected from the target object may not provide the parallax necessary for many 3D scanning applications.

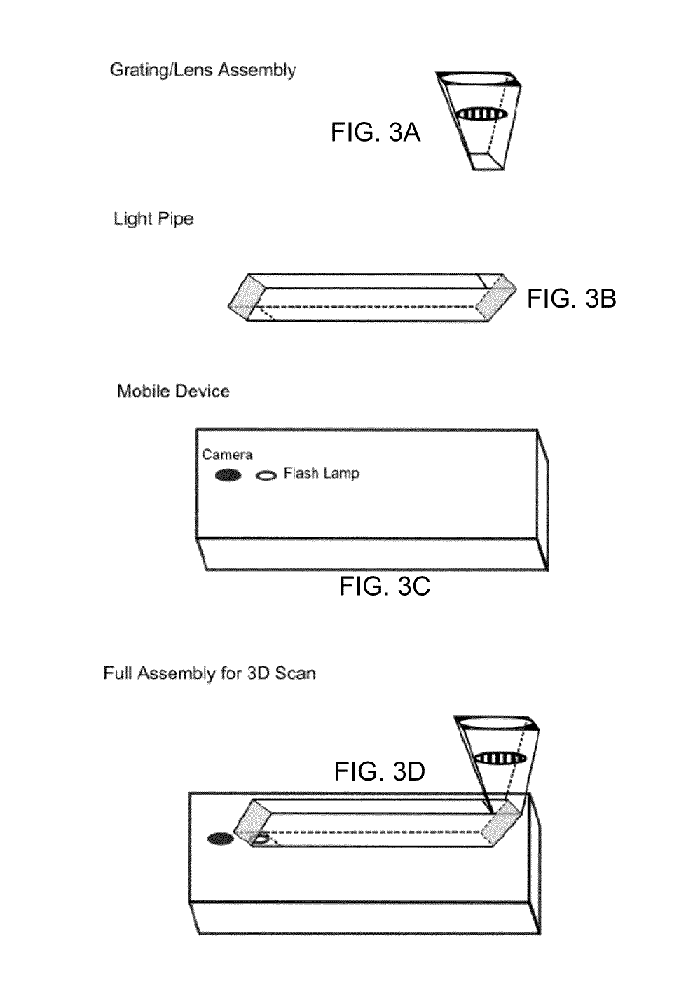

Thus, as shown in FIG. 3, a projector having a light pipe may be used to provide a greater separation distance between the camera and the source of the structured light pattern required for 3D mapping applications. The light pipe includes an interface at a first terminus that may be placed against the integrated flash lamp of the mobile device to collect light therefrom. After traveling along the length of the light pipe, light from the flash lamp is directed to an assembly that includes a grating and lens.

In operation, the projector may be immobilized relative to, e.g., affixed to, the mobile device. As a result, the camera and the lens of the projector may be located at a fixed distance from each other. To provide a sufficient parallax for static 3D contour mapping purposes, a separation distance of at least about 2 cm should be provided between the camera and the lens of the projector. Optionally, a greater separation distance, e.g., of at least 5 cm, may be provided for a greater parallax. Such distances should be sufficient for digital cameras of about 8 megapixels. In contrast, it may be possible to provide a lesser separation distance, e.g., between about 1 cm or 1.5 cm and 2 cm for cameras that with image sensors contain a greater number of pixels, e.g., of about 40 megapixels.

For digital cameras, structured light techniques may yield distance information in units of camera pixels. Since each pixel effectively holds a discrete measure of angular data, angular pixel data may be translated into physical distances to provide a 3D representation of the target object. This distance information can be determined if the geometric relationship between the scanned object, a structured light source and optical recording devices are known. As discussed above, the distance between a structured light source and optical recording device may be fixed and known by virtue of construction of the projector. The remaining aspects of the geometric relationship associated with the target object must be determined.

There are multiple techniques that can help determine the geometric relationship between the target object and the light source. For example, camera autofocusing technologies known those of ordinary skill in the art may be used to generate information for such geometric relationships. In particular, an automatically determined focal length for a zoom lens of the camera may yield information relating to the distance between the camera target object. Either or both active and passive, e.g., phase and/or contrast detection, autofocusing involving techniques may be used.

Periodicity of the structured light pattern may be used as well. Generally, the structured light source will have a single target focal plane, and the periodicity will be known by calibration of the camera with an object exactly in the target focal plane. If the object has moved out of the focal plane either towards or away from the camera and illumination source, the periodicity of the projected pattern will change and indicate the range distance to the target object.

Furthermore, distance estimators of the invention do not have to be optical in nature. Sonic technologies may be used as well. For example, many portable devices having integrated cameras also include audio components such as speakers and microphones. Such speakers and microphones may be used to carry out sonar techniques. For example, the portable device may direct a sound wave toward the target object. By measuring the time of flight of sound waves generated by the device's speaker, reflected from the target object, and reaching the device's microphone, it should be possible to determine information relating to the distance between the target object and the device.

In any case, once the target object has been imaged by the optical recording device, persons of ordinary skill in the art should be able to put together the computational resources to compute a point cloud from the above-described geometric and imaging information. Such a point cloud may serve as a digital 3D map for use in producing items with custom surface contours.

Exemplary Multicomponent Item: Foot Orthotics

From the above-described technique, a digital 3D map may be generated and used to produce a multicomponent item having a desired surface contour. In some instances, the surface may contour may be customized for an individual. For example, a custom component may be formed from a digital 3D map associated with the individual. Once formed, the custom component may be bonded to a stock component to form the multicomponent item such that the customized surface contour is associated at least in part with a surface of the custom component.

Inexpensive custom orthotics represents an exemplary item suitable for production via the invention technique. Exemplary orthotics include contoured inserts for shoes that support of an individual's foot or feet. Such orthotics make common tasks like standing, running, and walking more comfortable, and prevent and remedy painful foot conditions such as collapsed arches.

Generally, there are two types of orthotics. The first is fully custom orthotic, while the second is mass-manufactured and inexpensive. Custom orthotics are expensive, but may provide the better performance than their mass-manufactured counterpart. To form custom orthotics, a trained specialist (e.g. a podiatrist) typically fits the customer's foot by creating a mold for the orthotic. Then a fully custom orthotic is fabricated based upon the mold. The cost of custom orthotics is high because it requires the time of an expensive specialist, and because manufacturing of one-of-a-kind products cannot benefit from economies of scale (e.g. bulk purchasing).

In contrast, mass-manufactured orthotics are inexpensive, but exhibit lower performance. They are mass produced using a limited number of pre-existing generic molds. For each customer, the closest approximate pre-existing mold is selected (e.g. based upon criteria such as foot size, width, arch shape, weight, height, etc.). Accordingly, mass produced orthotics cannot account for any unique characteristics of any particular individual's foot (e.g., when an individual is missing a toe, when the individual exhibits an odd gait due to upper leg injury, when the individual has different sized left and right foot, etc.), or any characteristics that are not incorporated into mold selection at the factory.

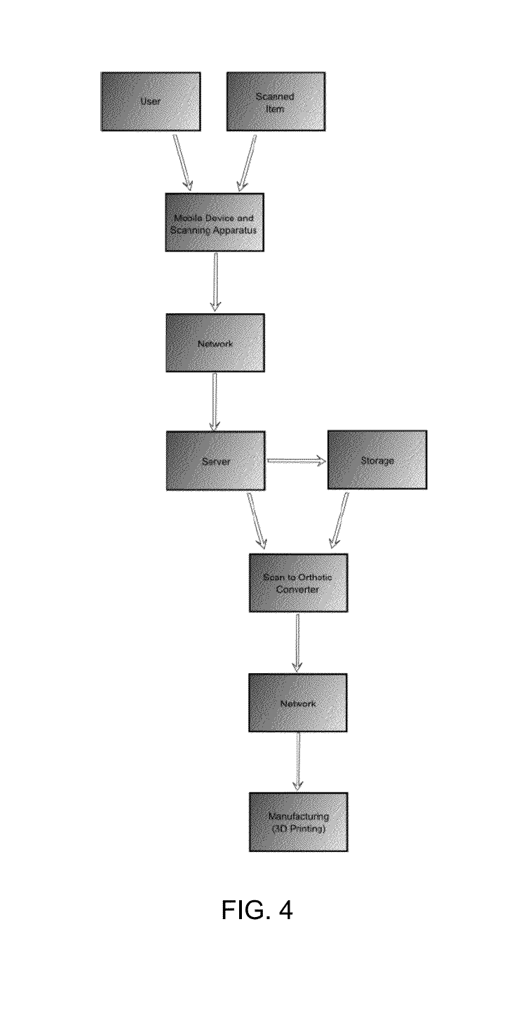

Thus, the invention also pertains to systems that may be used to deliver inexpensive, custom orthotics. As shown in FIG. 4, the system employs 3D mapping techniques in which a user may deploy apparatuses that include portable devices and structured light patterns to scan a target object, e.g., a foot, thereby producing image of the target object. Information technology infrastructure associated with mobile devices, e.g., computer networking resources and internet accessing capabilities, may be used to deliver such images to servers and associated electronic storage media that translate 3D mapping information with the target object, e.g., a 3D point cloud scan of a foot, into manufacturing instructions for orthotics for the foot, e.g., via 3D printing.

The information technology infrastructure associated with mobile devices may be provide a number of advantages over traditional orthotic manufacturing techniques, custom or mass-produced. For example, once a mobile device is used to 3D scan a target object (e.g. a foot), the foot scan and point cloud data may be sent in a substantially instantaneous manner from the mobile device to a server or orthotic manufacturer. The foot scans may be then stored in a database of orthotic shape information for later use (e.g. analysis and optimization) and retrieval. Such archival techniques eliminate the need in traditional orthotics production techniques in which a physical mold must be created, sent to an orthotic manufacturer, and stored. Similarly, electronic archival techniques have not been available for individuals fit for mass-manufactured orthotics.

In addition, once orthotic information is available in a digital electronic format, a wide range of options for orthotic manufacturing becomes available. For example, digitization allows for the creation and expansion of large databases of information pertaining to individual foot shapes, weights, heights, inseams, shoe sizes, shoe styles, and shoe brands. Information relating to how much individuals weigh and their gait may also be included in the databases. Feedback regarding how well particular orthotics have performed in the past may also be entered in such a database. In turn, individual and/or collective information may be used to help produce better fitting orthotics.

There are a number of operational parameters may enhance how a 3D scan may work in the context of orthotics. As discussed above, an image is produced from structured light reflected by the target object. In some instances, when the image is obtained with a specific background (e.g. a black surface) behind the foot, brightness and/or color may determine the location of the foot. In such a case, it is a fairly straightforward matter to isolate the foot from the background of the image to produce a point cloud of the foot therefrom.

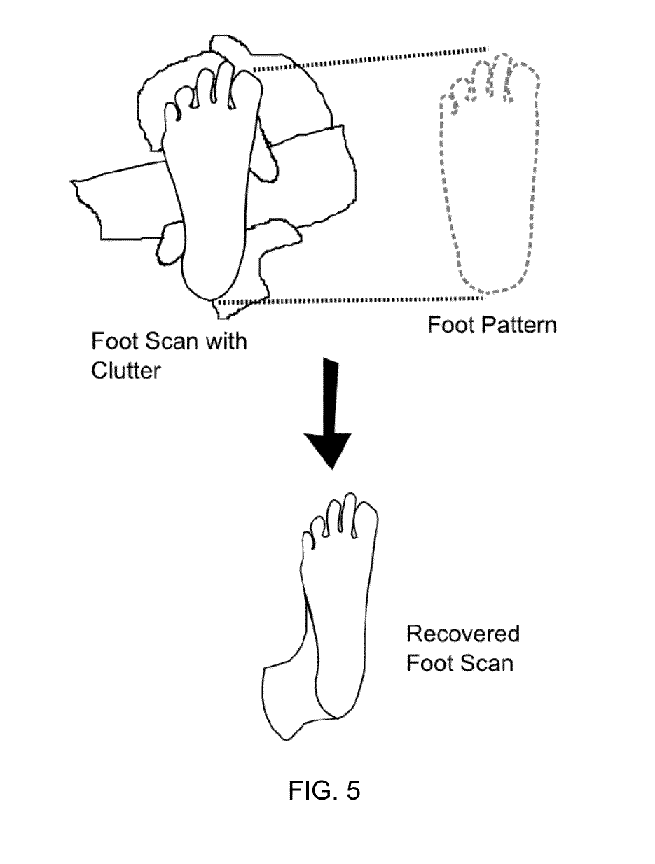

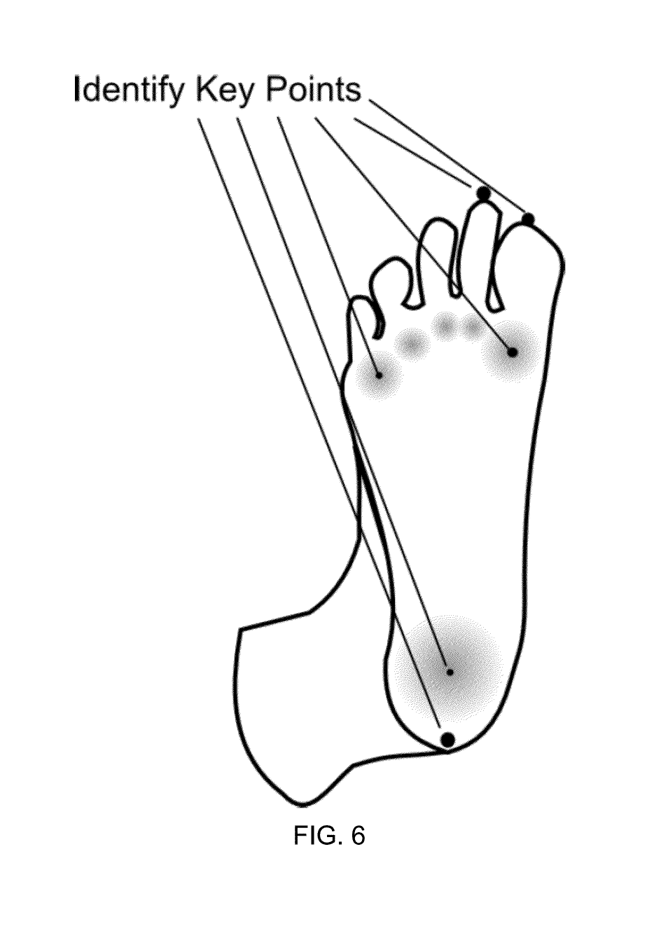

Alternatively, no specific background is provided. Instead, arbitrary background condition may be used. In such a case, as shown in FIG. 5, post-processing analysis may be carried out. For example, image processing technology may compare a model of a foot against objects in the scanned image. In some cases, the model may be produced using information from the database described above. As a result, the foot may be isolated from extraneous background clutter. Then, as shown in FIG. 6, isolated image of the foot may be analyzed to identify/locate key points on the foot (e.g. features such as a heel or big toe).

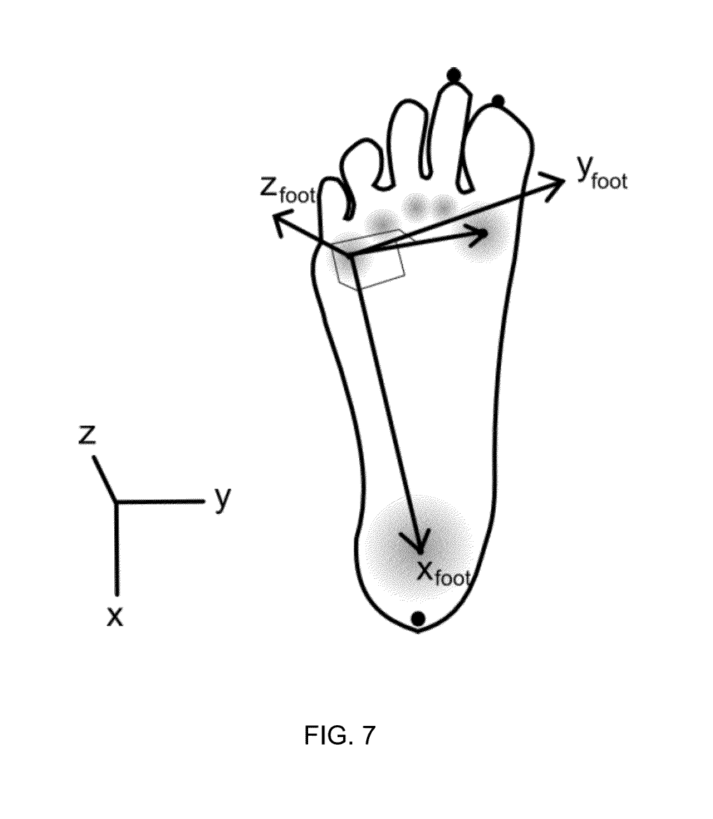

Image processing technologies may also correct for imperfect images. For example, a foot surface may not be positioned perpendicular to the camera during scanning. Instead, a pronated foot image may be obtained from an improper camera perspective. Point clouds generated directly such an image would exhibit the same pronation. In turn, orthotics produced from such point cloud would exhibit the same flaw. Thus, as illustrated in FIG. 7, 3D techniques known in the art that correct/rotate point clouds may be used to compensate for tilt of foot with respect to camera.

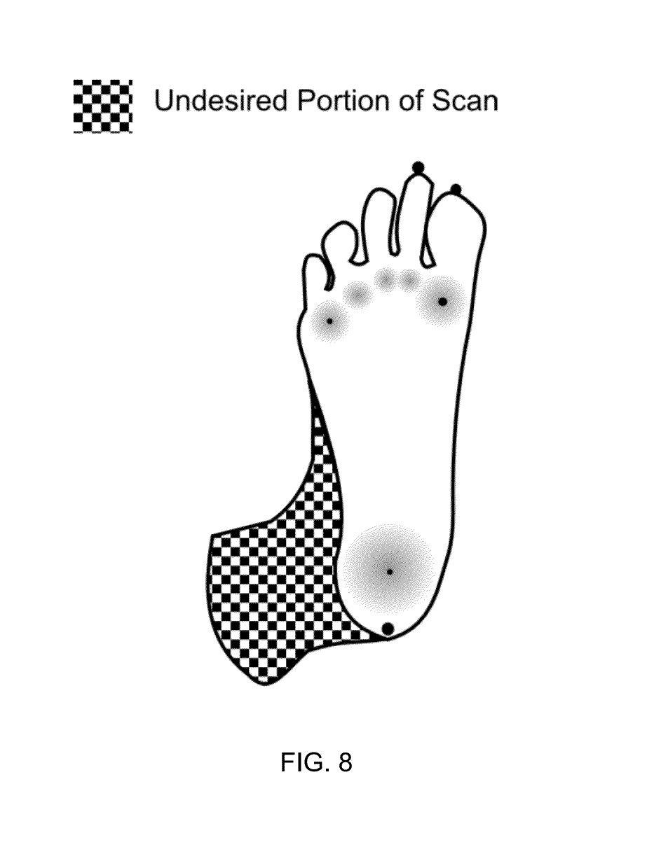

In some instances, 3D images of the foot may contain information that is unhelpful for the construction of an orthotic (e.g. the upper portion of the ankle). As shown in FIG. 8, parts of the foot point cloud may be discarded to simplify construction of an orthotic. Choosing whether to discard parts of the foot point cloud may involve criteria such as height and slope determinations. Points located at an excessive height correspond to the top of the foot or ankle whereas points located at a lower heights correspond to the bottom of the foot which. Thus for orthotic shoe insert, points at the excessive height may be discarded. Similarly, points located at a region with an excessively steep slope correspond to edge regions of the bottom of the foot. Edge regions may serve to define a boundary beyond which points may be discarded. In some embodiments, the thresholds for determining unwanted areas such as ankles are tunable.

As alluded to above, there is also value in utilizing the database of stored foot and orthotic point clouds on the server from a variety of different users, in conjunction with data about the user such as weight, or how they walk (gait), which can be measured from accelerometers and other sensors on the user. For example, since the user's foot deforms under pressure, allowances may need to be made for the weight of the user. Or, if the user's gait indicates a person who strikes the ground with their heel, then changes to the shape of the orthotic can be made accordingly.

In some embodiments, the construction of the orthotic from the foot point cloud data should take into account the shoe in which it will fit. If the shoe is a high-heel or pump shoe, versus a running shoe, the shape of the orthotic is adjusted accordingly. The shape of the orthotic may also depends on the size of the individual's shoe.

Accordingly, it may be useful to determine the interior shape of the shoe in which the orthotic will fit. There are various techniques that will yield this information. For example, the interior of the shoe may be scanned with structured light techniques, e.g., using a mobile device. Alternatively, interior photographs of shoe interiors may be used for dimensional estimations.

Production Techniques

Once the point cloud of the orthotic has been created, the physical orthotic (or any item with a desired surface contour) may be manufactured. Any of a number of production techniques may be used. Typically, some or all of the items orthotic will be manufactured using 3D printing techniques. However, other manufacturing techniques, e.g., injection molding, casting, shearing, stamping, and combinations thereof, may be used as well to supplement or as an alternative to 3D printing techniques.

Any of a number of different three-dimensional printing techniques may be employed to practice the invention. For example, laser sintering techniques may be used to form three-dimensional structures of desired shapes. Such techniques typically involve spreading loosely compacted particulate matter, e.g., in the form of plastic powder, evenly onto a flat surface with a roller mechanism. The thin particulate layer is then raster-scanned with a high-power laser beam. The particulate matter that is struck by the laser beam is fused together. The areas not hit by the laser beam remain loose and fluent. Successive layers are deposited and raster-scanned, one on top of another, until an entire structure is complete. Each layer is sintered to a sufficient degree to ensure its bonding to its preceding layer.

Another suitable three-dimensional printing technique involves using an inkjet stream of fluid to create three-dimensional objects under computer control in a manner similar to the way an ink jet printer produces two-dimensional graphic printing. In some instances, a metal, metal alloy or metal composite part may be produced by ink-jet printing liquid metals to form successive cross sections, one layer after another, to a target using a cold welding (i.e., rapid solidification) technique, which causes bonding between the particles and the successive layers. Other fluids suitable for using inkjet applications include, e.g., fluids containing a conductive material such as metallic nanoparticles optionally functionalized or encapsulated by organic moieties, or a fluid containing a conductive precursor such as an organometallic compounds.

Still another suitable three-dimensional printing technique is described in U.S. Pat. No. 5,204,055 to Sachs et al. The technique involves first depositing a layer of a fluent porous material in a confined region and then depositing a binder material to selected regions of the layer material to produce a layer of bonded material at the selected regions. The steps are repeated a selected number of times according to a computer model to produce successive layers of selected regions of bonded material to form a desired component. The unbonded material is then removed. In some cases the component may be strengthened, for example, via heating.

U.S. Pat. Nos. 5,807,437 and 6,146,567, each to Sachs et al., describes an improvement to the above-described technique. In general, a binder printhead is provided having an array of nozzles, which controllably supply jets of binder material droplets to the layers of porous material. The printhead is scanned in a raster scan fashion over each layer of porous material along a first scan axis in one direction to provide first fast scanning paths of droplets. The printhead is then moved laterally of such one direction and is then moved along the fast-scan axis in the opposite direction to provide second fast scanning paths of droplets which are interlaced with those deposited via the first scanning paths. The supply of the droplets to the porous material can be controlled ensure optimal scanning path overlapping to produce various desired surface and interior characteristics of the components. Optionally, the droplets may be electrically charged.

Depending on how the invention is practiced, different particulate matter may be employed. In general, the particulate matter must be suitable for its intended use. For example, when the particulate matter is used to produce a mold for forming a freestanding structure on a substrate, the particulate matter should be selected so that the mold formed as a result may be readily removed from the substrate surface. In particular, the mold should be readily removable without disturbing the molded structure. Since dissimilar materials tend to be more easily separated from each other than similar materials, one of ordinary skill in the art may select particulate material for mold forming applications so that it differs in composition from the freestanding conductive structure to be formed.

Thus, depending on the particular practice of the invention, the particulate matter associated with the invention may be of any class or combination of materials. Polymeric materials, e.g., of an elastic modulus of about 0.01 to about 20 GPa, may be used. For example, polyimides are known for their chemical stability and their ability to withstand harsh chemical environments associated with semiconductor packaging applications. At the same time, certain polyimides are chemically etchable in hot potassium hydroxide for removal. Other polymeric materials include, but are not limited to, polyesters such as polyethylene terephthalate and polyethylene naphthalate, polyalkanes such as polyethylene, polypropylene and polybutylene, halogenated polymers such as partially and fully fluorinated polyalkanes and partially and fully chlorinated polyalkanes, polycarbonate, epoxies, and polysiloxanes.

Feature resolution also represents an important aspect of the invention, and a number of factors may dictate feature resolution. For orthotics like shoe inserts, a feature resolution of 2 mm or less it typically acceptable. Courser feature resolutions may be acceptable for other items, e.g., back brace.

One important factor is the size of the particulate matter used. In general, particulate matter of a smaller particle size tends to lead to finer feature resolution. Nevertheless, smaller particles have a greater surface area per volume. In turn, surface forces tend to have a greater effect on particulate matter of a smaller particle size than those of a larger size.

Another factor that affects feature resolution is the composition of the particulate matter. For example, some embodiments of the invention may involve the deposition of particulate matter in the form of droplets of a solution from which a solute may be precipitated out of solution when the solvent is removed. In such a case, droplets having a lower concentration of solute tend to produce a structure having a finer feature resolution than droplets of the same volume having a higher concentration.

Still another factor that affects resolution relates to how particulate matter is deposited. For example, while inkjet technology may control droplet deposition by a printhead at intervals of 1/300 inch, or approximately 85 microns, such a 300 dots-per-inch droplet placement may be insufficient for the creation of three-dimensional structures of a fine feature resolution. Structures formed using 300 dots-per-inch placement may exhibit a generally rough surface finish. In addition, the printhead, upon repeated use may experience clogging and may require cleaning and other types of maintenance to ensure that droplet size and trajectory remain within predetermined parameters. Further problems with ordinary inkjet technologies as applied to three-dimensional printing are described in U.S. Pat. No. 5,204,055 to Sachs et al.

To effect the degree of control over feature resolution associated with the invention, a three-dimensional printer for dispensing particulate matter of an appropriate particle size and may be used in conjunction with 3D mapping information relating to the item to be formed (or a mold thereof). Such information may be handled by computer-aided design (CAD) software. For example, the invention may employ a direct-write system that takes the 3D point cloud information from a CAD-type system and directly prints it onto a substrate. Those of ordinary skill in the art should be able to integrate this type of capability into a three-dimensional printer as such printers routinely take 3D cloud point files and develop prototypes.

### OTHER USES

From the above description, it should be that the inventive 3D mapping technologies may find other uses. For example, when numerous mass-manufactured orthotics of varying sizes and shapes are available, the 3D mapping technologies described herein may help individuals select the best orthotic therefrom. In addition, the invention may be used to produce customized shoes wherein some or all of a shoe is custom-manufactured to conform to the shape of the wearer's feet. Furthermore, the invention may be used to produce customized ski boots (or inserts therefor) having a surface contour personalized to an individual's feet and ankles.

The invention is not limited to 3D scans of feet. For example, the invention may also find use in medical and/or biomedical devices. For example, the invention may be used to form hearing aid contoured to fit individual ears. Other examples of medical and/or biomedical that may be improved with the invention include prosthetic body parts, braces (e.g., neck braces), dental devices that conform to the shape of an individual's teeth (reconstructed or otherwise).

Ergonomic devices may also benefit from the invention. Such devices include furniture having a surface contour that conform to an individual's back side, e.g., chairs, car seats, seat back cushions, etc., or arms, e.g., arm rests. The invention may also be used to manufacture beds and other furniture that may conform to an individual's entire body.

Additional variations of the present invention will be apparent to those of ordinary skill in the art. Upon routine experimentation, those skilled in the art may find that the invention may be incorporated into existing equipment or vice versa. For example, the invention may be used in conjunction with traditional orthotics manufacturing techniques involving positive and negative molds. In some cases, the invention may be used to scan a target object so as to produce a form fitting packaging unit for the target object.

It is to be understood that, while the invention has been described in conjunction with the preferred specific embodiments thereof, the foregoing description is intended to illustrate and not limit the scope of the invention. Any aspects of the invention discussed herein may be included or excluded as appropriate. For example, any aspect may be used by themselves or in combination. Other aspects, advantages, and modifications within the scope of the invention will be apparent to those skilled in the art to which the invention pertains.

All patents, patent applications, and publications mentioned herein are hereby incorporated by reference in their entireties to an extent not inconsistent with the above disclosure.

What is claimed is:

1. A 3D mapping apparatus, comprising:
a light source;
a projector for projecting a structured light pattern onto a target object for 3D mapping, comprising
an interface enabled to collect light from the light source,
a grating that corresponds to the structured light pattern, and
a lenses interposed between the light source and the target object; and
a portable device comprising
an integrated camera enabled to capture structured light reflected from the target object and generated an image therefrom, and
a storage medium enabled store the image generated by the camera,
wherein camera and the lens of the projector are located at a pre-determined distance from each other.

2. The apparatus of claim 1, wherein the light source is an integrated component of the portable device.

3. The apparatus of claim 1, wherein the projector is affixed to the portable device.

4. The apparatus of claim 2, wherein the projector includes a light pipe.

5. The apparatus of claim 1, wherein the portable device is a tablet computer.

6. The apparatus of claim 1, wherein the portable device is a cellular phone.

7. The apparatus of claim 1, wherein the camera is a digital single-lens reflex camera.

8. The apparatus of claim 1, wherein the predetermined distance between camera and the lens of the projector is no less than about 2 cm.

9. The apparatus of claim 1, wherein the portable device further comprises a distance estimator for estimating the distance between the camera and the target object.

10. A multicomponent item having a desired surface contour, comprising:
a first component comprising a first surface and a first bonding surface;
a second component comprising a custom surface and a second bonding surface,
wherein the first bonding surface and second bonding surface are enabled to bond with each other, and the custom surface forms at least a portion of the desired surface contour of the item.

11. The item of claim 10, wherein the first component is a stock component.

12. The item of claim 10, wherein the desired surface contour is conformal with respect to the individual's neck, back, ear, tooth, wrist, hand, finger, ankle, and/or foot.

13. The item of claim 10, further comprising a third component having a surface located within footwear.

14. A method for producing a multicomponent item having a surface contour customized for an individual, comprising:
(a) obtaining a digital 3D map associated with the individual;
(b) forming a custom component from the digital 3D map; and
(c) bonding the custom component to a stock component to form the multicomponent item, wherein the customized surface contour is associated at least in part with a surface of the custom component.

15. The method of claim 14, wherein step (a) comprises:
(a1) projecting a structured light pattern from an incident direction onto the individual;
(a2) receiving light reflected from the individual at an angle of greater than zero to about ninety degrees relative to the incident direction; and
(a3) producing the digital 3D map from the light received in step (a2).

16. The method of claim 15, wherein the data file, in step (a1), provides an unaltered 3D image of the individual and the data file, in step (a2) is rotated and/or translated to produce the digital 3D map, thereby setting forth a design from which the custom component may be formed.

17. The method of claim 14, wherein step (a) is carried out using a device having an integrated camera, storage medium, and a projector.

18. The method of claim 14, wherein step (a) is carried out using a device with an integrated camera and storage medium and an attached 3D scanning apparatus.

19. The method of claim 38, where the attached 3D scanning apparatus comprises a structured light projector.

20. The item of claim 14, wherein step (c) is carried out using a 3D printer.
